(19) United States
(12) Patent Application Publication
(10) Pub. No.: US 2009/0177390 A1
(43) Pub. Date: Jul. 9, 2009

(54) Navigation device and method for updating a digital map

(76) Inventor: Lubos Mikusiak, Nieuw Vennep (NL)

Correspondence Address: TOMTOM INTERNATIONAL B.V., REMBRANDTPLEIN 35, AMSTERDAM, 1017CT, NL

(21) Appl. No.: 12/007,133

(22) Filed: Jan. 7, 2008

(51) Int. Cl. G01C 21/32

(52) U.S. Cl. 701/210; 342/357.13

(57) ABSTRACT

A method of updating a digital map is disclosed, the method comprising:
retrieving preference information defining a first portion of the digital map for which update information is desired;
acquiring update information selectively for the first portion of the digital map; and
applying the acquired update information to the digital map.

### FIELD OF THE INVENTION

This invention relates to navigation devices and methods of navigation. Illustrative embodiments of the invention relate to portable navigation devices (so-called PNDs), in particular PNDs that include Global Positioning System (GPS) signal reception and processing functionality. Other embodiments relate, more generally, to any type of portable or in-vehicle processing device that is configured to execute navigation software so as to provide route planning functionality.

### BACKGROUND TO THE INVENTION

Navigation devices that include GPS (Global Positioning System) signal reception and processing functionality are well known and are widely employed as in-car or other vehicle navigation systems.

In general terms, a modern navigation device comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device. For example, in the case of a PND, a USB interface may optionally allow the device to be coupled to a PC. Optionally a wireless transmitter/receiver allows a PND or an in-vehicle navigation device to communicate over a cellular telecommunications network.

Navigation devices of this type also include, or at least include a connection for, a GPS antenna by means of which satellite-broadcast signals, including location data, can be received and subsequently processed to determine a current location of the device.

The navigation device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices.

The utility of such navigation devices is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

A navigation device of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the navigation device forms one primary function, and navigation along such a route is another primary function.

During navigation along a calculated route, it is usual for the navigation device to provide visual and/or audible instructions to guide the user along a chosen route to the end of that route, i.e. the desired destination. It is also usual for the navigation device to display map information on-screen during the navigation, such information regularly being updated on-screen so that the map information displayed is representative of the current location of the device, and thus of the user or user's vehicle if the device is being used for vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of navigation devices, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

The effectiveness of a navigation device depends on the map data in the device being accurate and up to date. However, the map data can be vast, and updating the map data can be very time consuming, especially if the map data is stored in a memory medium that is relatively slow to write, such as flash memory. Moreover, updating of the map data can require significant memory overhead while a new map version is prepared from a current map version before the current map version is then replaced. The quantity of data that needs to be downloaded can also be problematic, especially over slow communication networks, or networks for which a customer is charged according to the quantity of data communicated.

It is an aim of the present invention to address these problems.

### SUMMARY OF THE INVENTION

In pursuit of this aim, a presently preferred embodiment of the present invention provides a method of updating a digital map, comprising:

retrieving preference information defining a first portion of the digital map for which update information is desired;

acquiring update information selectively for the first portion of the digital map; and

applying the acquired update information to the digital map.

Other aspects of the invention are defined in the claims.

Features and advantages of the invention include one or more of: (i) the ability to select and/or prioritise which areas of the map are updated; (ii) increasing the speed of updating important areas of the map according to priority; (iii) increasing the efficiency of network communication, by avoiding or de-prioritising update information for map regions that are not important to a user; and (iv) enhancing the versatility of the update information by dividing the update information in segments for different geographical areas.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIGS. 4A and 4B are illustrative perspective views of an implementation of an embodiment of the navigation device;

FIG. 5 is a schematic block view of an operating environment in the navigation device;

FIG. 6 is a schematic view of segmenting of map update information;

FIG. 7 is a schematic view showing updated geographical areas of an electronic map;

FIG. 8 is a schematic view of a display of user-selectable preference options for a map updating operation;

FIG. 9 is a schematic view illustrating the relation between the preference options and map update information; and

FIG. 10 is a schematic flow diagram showing a first method for acquiring and applying map update information;

FIG. 11 is a schematic flow diagram showing a second method for acquiring and applying map update information;

FIG. 12 is a schematic flow diagram showing a third method for acquiring and applying map update information; and

FIG. 13 is a schematic flow diagram illustrating generally a method executing by the map updater module.

### DETAILED DESCRIPTION OF PREFERRED EMBODIMENTS

Preferred embodiments of the present invention will now be described with particular reference to a PND. It should be remembered, however, that the teachings of the present invention are not limited to PNDs but are instead universally applicable to all apparatuses using digital maps, including navigation devices of all types. In particular it should be noted that by navigation device we mean any type of route planning device, irrespective of whether that device is embodied as a PND, a navigation device built into a vehicle, or indeed a computing resource (such as a desktop or portable personal computer (PC), mobile telephone or portable digital assistant (PDA)) executing any of positioning system, map matching, route planning and navigation software.

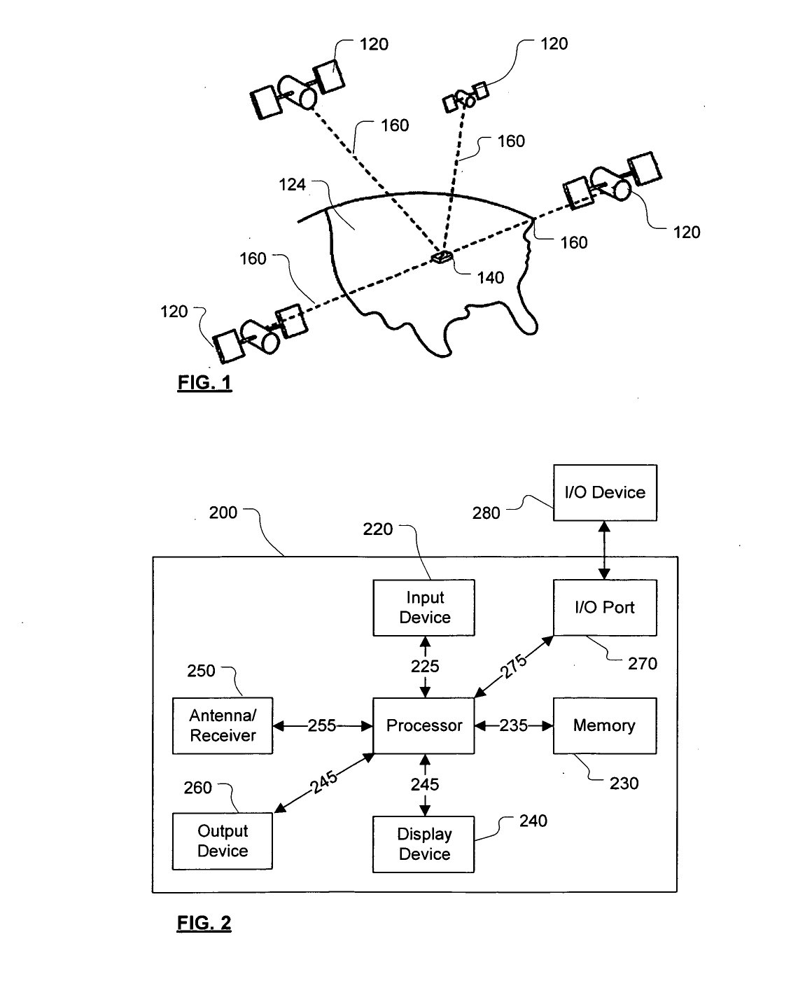

FIG. 1 illustrates an example view of Global Positioning System (GPS), which is one example of a positioning system (PS) usable by a navigation device. Other satellite and/or terrestrial based PSs may also be used as desired in order for a navigation device to determine its own position. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

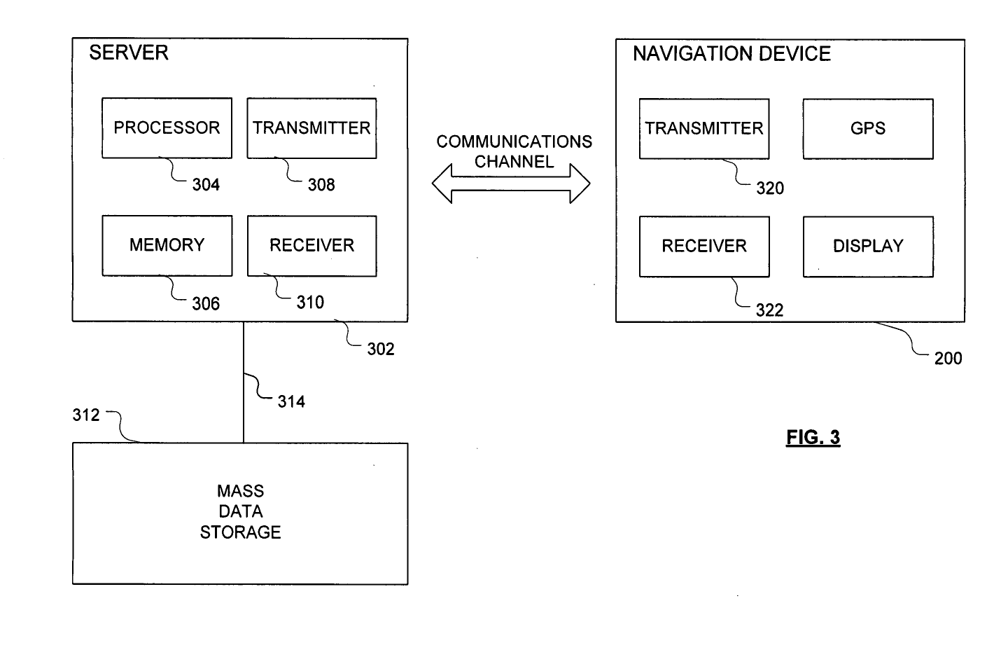

FIG. 2 is an illustrative representation of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In a particularly preferred arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GRPS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, or a wired or wireless (e.g. Wifi) network connection via a router).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

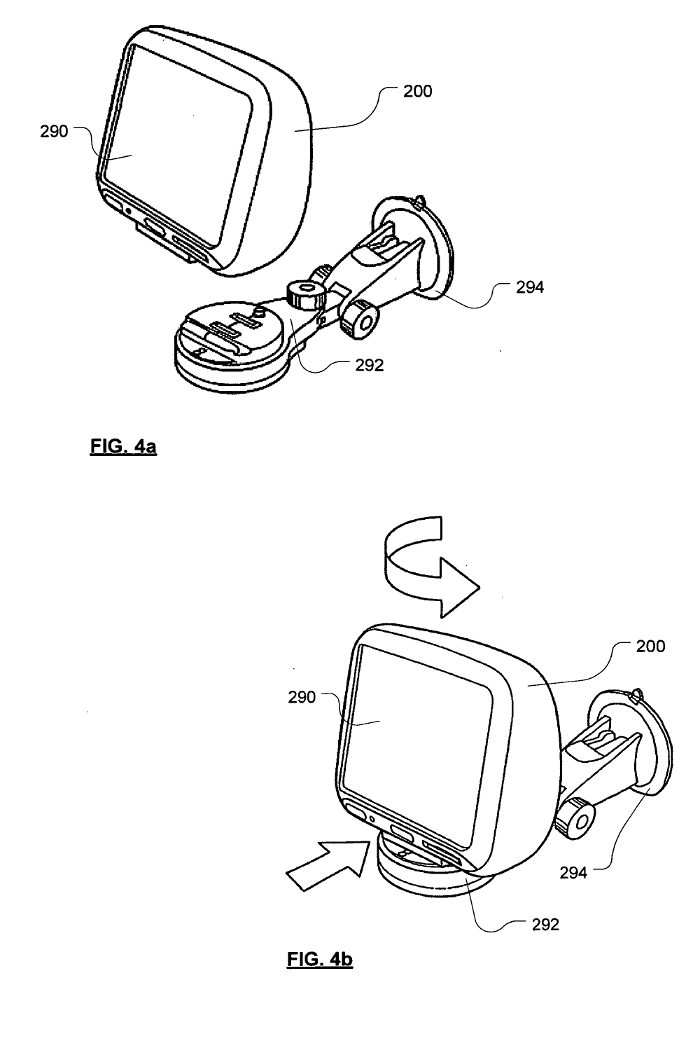

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

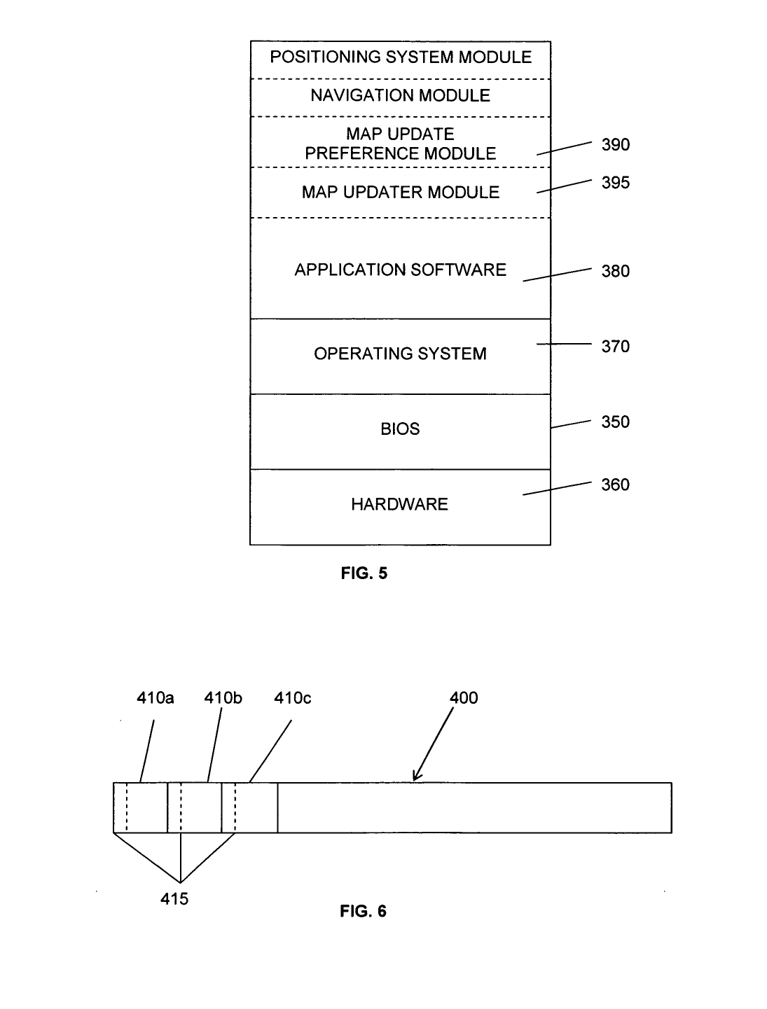

Referring to FIG. 5, the processor 210 and memory 230 cooperate to establish a BIOS (Basic Input/Output System) 350 that functions as an interface between the functional hardware components 360 of the navigation device 200 and the software executed by the device. The processor then loads from memory 210 an operating system 370 which provides an environment in which application software 380 (implementing some or all of the abovedescribed functionality) can run. In accordance with the preferred embodiment of the present invention, part of this functionality comprises a map update preference module 390, and a map updater module 395, the functions of which will become apparent from the description below.

Referring to FIG. 6, the server provides map update data 400 for updating the electronic map data stored in a navigation device 200. The map update data 400 is divided into data partitions or segments 410. Each segment 410 may optionally be limited to a physical size data size, for example a few kilobytes. By limiting the size of the data segments, the amount of memory needed in the navigation device 200 to apply the update can similarly be reduced. In other words, instead of having to generate a new version of the entire map data before overwriting the previous version, only a small segment of the map data needs to be updated.

Additionally or alternatively, each segment 410 may contain update data that is confined to a respective localised geographic area of the map, possibly being limited in terms of m², or other unit of area, or possibly by city, village or town limits or boundaries, e.g. possibly by postcode. Each segment 410 may include a geographic label 415 indicating on the map the area, or coordinates of the area, that are affected by the update information in the segment 410. By limiting the data segments to localised geographic areas, the amount of memory needed in the navigation device to apply the update can also be reduced. In other words, instead of having to generate a new version of the entire map data before overwriting the previous version, only a small geographically localised region of the map data needs to be updated in order to apply the segment 410 update. Moreover, the geographic label 415 also permits the possibility of selective or customized updating of map data in an individual navigation device 200 according to geographic preferences.

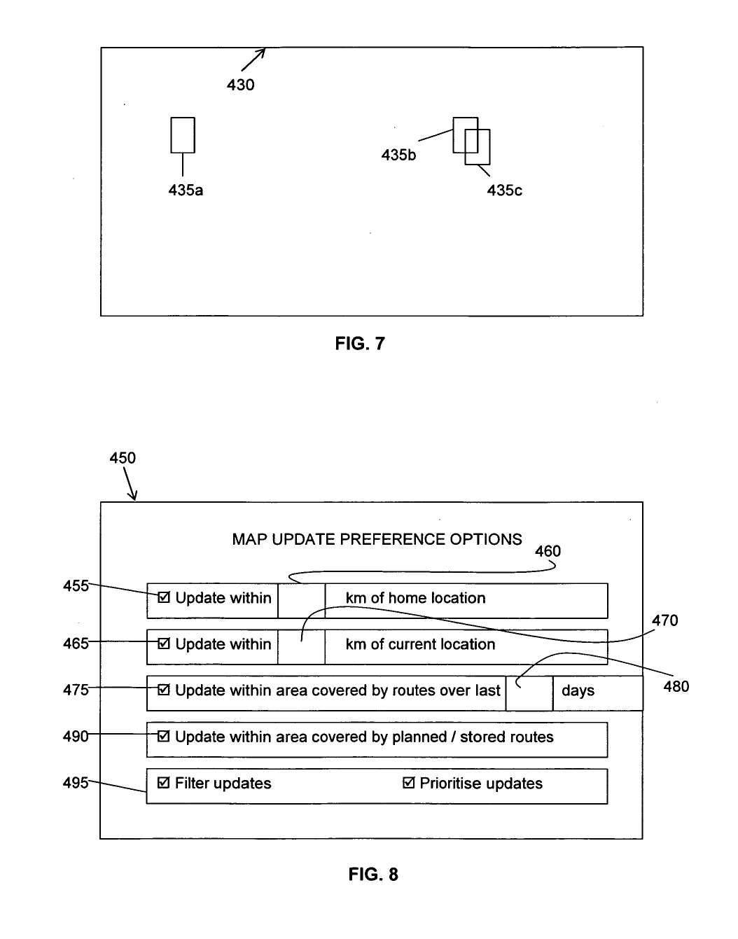

FIG. 7 illustrates by way of example, how different segments 410a, b and c might relate to a digital map 430. A first update segment 410a relates to a first geographic area 435a, and a second update segment relates to a second geographic area 435b spaced from the first geographic area. For the purposes of illustration, the geographic areas 435 are depicted as rectangles, but each segment may have its own arbitrary shape. Also, it is not essential in all embodiments that the update segments are non-overlapping. Update segment 435c may relate to a third geographic area that overlaps partly with one of the other geographic areas. The update segments 435 may directly replace the map data for the geographic area, or the update segments may “patch” the map data within the geographic area (e.g. just updating the map data that needs to be changed, while not interfering with unchanged map data in the geographic area). Version number tracking may be used to ensure that updates are applied in a correct priority order.

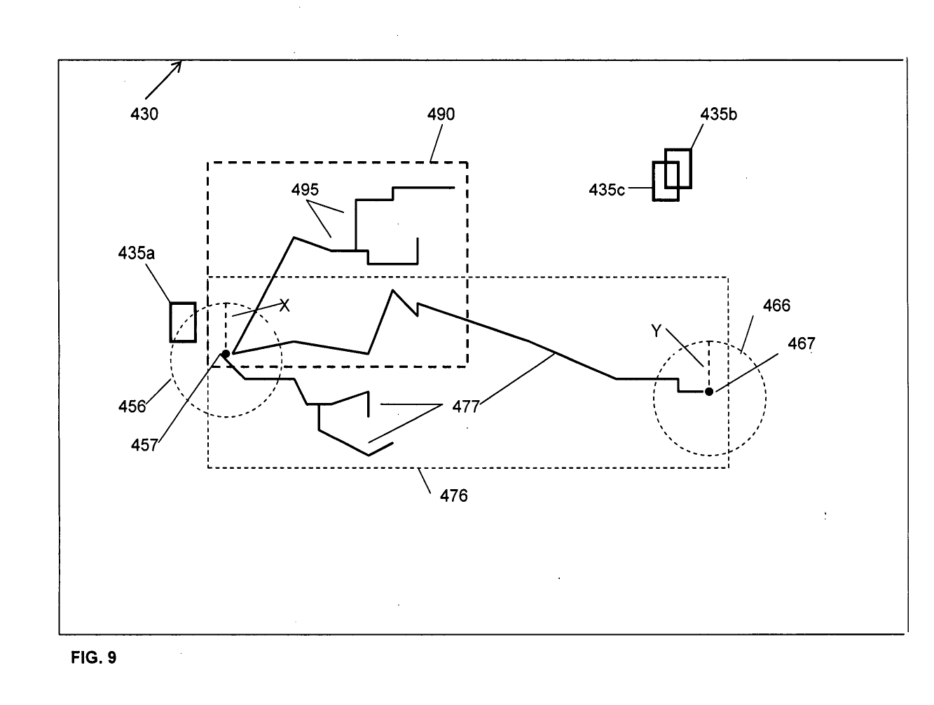

Referring to FIGS. 8 and 9, the map update preference module 390 functions to cause the processor 210 to create on the display a preference panel 450 by which a user can set and control preference parameters for the updating process. In the present example, the user can selectively activate one or more options from five alternatives:

(i) a first option 455 of selecting updates within a distance 456 of X km around a home location 457 defined for the navigation device. The value of X is editable in a field 460 of the display. The home location is a geographic location that the user can set to define where the user normally lives, using conventional navigation set-up preferences.
(ii) a second option 465 of selecting updates within a distance 466 of Y km around the current location 467 of the navigation device. The value of Y is editable in a field 470 of the display. The current location is the geographic location that the navigation device determines for itself, using the positioning system of the navigation device.
(iii) a third option 475 of selecting updates that relate to a geographic area 476 covered by recorded positions and routes 477 over the last Z days. The value of Z is editable in a field 480 of the display. The geographic area 476 may be a single area, such as a notional rectangle or other polygon around the regions of the map on which the recorded positions and routes occur, or it may be a plurality of spaced areas.
(iv) a fourth option 485 of selecting updates that relate to a geographic area 490 representing a buffer zone around pre-planned and/or favourite positions and routes 495 entered in the navigation device 200. The geographic area 490 may be a single area, such as a notional rectangle or other polygon around the regions of the map on which the positions and routes 495 occur, or it may be a plurality of spaced areas.
(v) a fifth option 497 of selecting between filtering the updates, or prioritising the updates, according to the aforementioned criteria. When filtering is selected, only the updates matching the criteria may be acquired and/or applied. When prioritising is selected, the most relevant updates matching the criteria are acquired and/or applied first, and lesser relevant updates that do not match the criteria are acquired and/or applied later. Prioritisation may be implemented in dependence of the distance between the geographical label 415 of a segment 410, and one or more of the geographic criteria, such that the greater the distance, the lesser the priority. Once a priority order has been established, the segments 410 may be downloaded and/or applied according to the priority order.

FIG. 9 illustrates example parameters from the preference panel 450, in relation to the digital map 430 of FIG. 7. It will be appreciated that the above preference parameters are merely examples, and that a smaller or larger set of these, or other, preference parameters may be implemented as desired. In an alternative embodiment, the preference parameters may be preset in the navigation device 200, and the map update preference module 390 may be omitted.

Once the parameters have been inputted, preference information is stored in the memory 230 of the navigation device 200. The preference information may directly represent the parameters, and/or it may represent the geographical areas 456, 466 476, 490 which define a first portion of the digital map 430 for which update information is desired, at least preferentially.

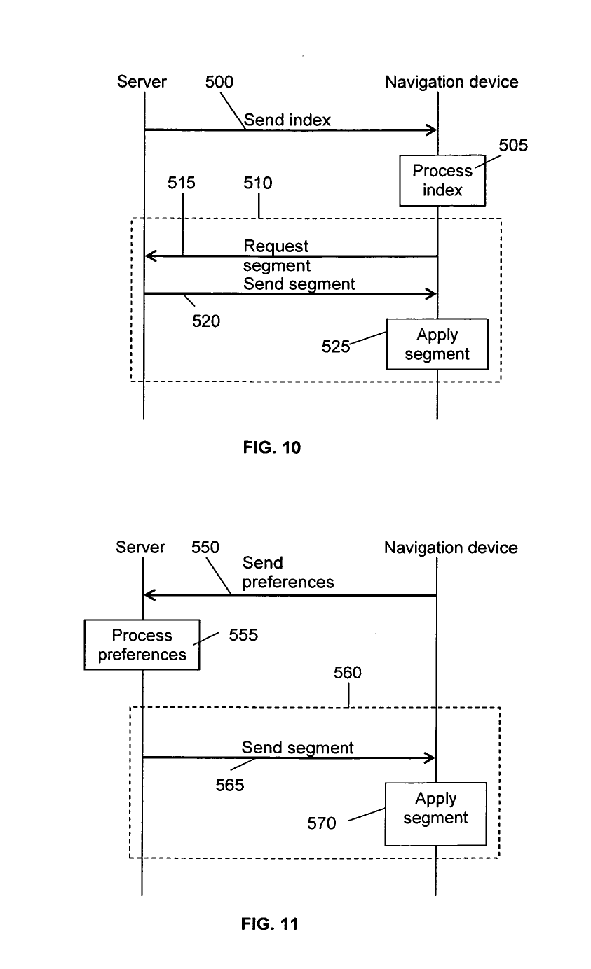

Referring to FIG. 13, the map updater module 395 functions to retrieve the preference information (step 620) and acquire and apply map update information to the digital map, in accordance with the preference information (step 625). As mentioned above, the map updater module 395 may establish communication with a server 302 via a communication channel. FIGS. 10-12 illustrate in more detail example methods for acquiring and applying the update information.

FIG. 10 illustrates a first example method by which appropriate update segments 410 can be acquired by the navigation device 200 from the server 302. In a first step 500, the server 302 transmits an index of available segments 410, and the respective geographic labels 415. At step 505, the navigation device 200 processes the received index to determine which segments 410 match the user preference criteria, and to determine a desired order of the segments according to priority. Step 510 is then executed as many times as necessary, consisting of the sub-steps: of the navigation device 200 requesting (step 515) a desired update segment; the server sending (step 520) the requested update segment; and the navigation device 200 applying (step 525) the update segment to update a portion of its map data. The step 510 is repeated as many times as necessary to acquire all of the desired updates. Using this method, the navigation device 200 controls the requesting of individual update segments 410.

FIG. 11 illustrates a second example method which may be used as an alternative to FIG. 10. In FIG. 11, at a first step 550, the navigation device 200 transmits preference information derived from the preference panel 450, to the server 302. At step 555, the server processes the received preference information to determine which segments 410 match the user preference criteria, and to determine a desired order of the segments according to priority. Step 560 is then executed as many times as necessary, consisting of the sub-steps: of the server sending (step 565) an appropriate update segment; and the navigation device 200 applying (step 570) the update segment to update a portion of its map data. The step 560 is repeated as many times as necessary to acquire all of the desired updates. Using this second method, the server 302 controls the sending of appropriate segments 410 according to preference information provided from the navigation device.

The first and second methods described above enable the transmission quantity, and transmission order, of update data to be tailored to preference parameters for an individual navigation device 200. This is especially beneficial when the communication channel is relatively slow, or the user has to pay according to the quantity of data sent over the network.

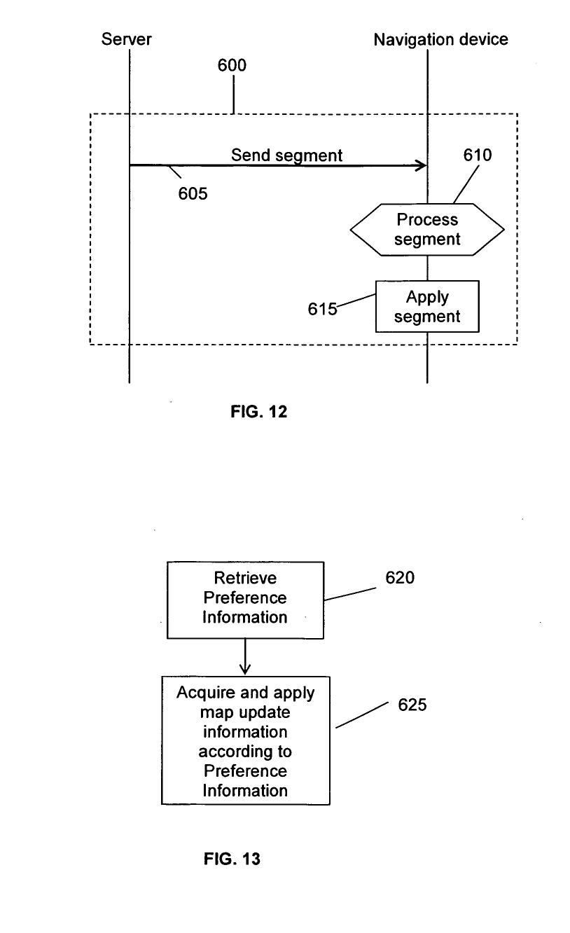

FIG. 12 illustrates an alternative method comprising a repeated step 600 of the transmitter sending (step 605) each segment 410 in turn as part of a predetermined transmission sequence. At the navigation device 200, the received segment 410 is processed to determine whether the geographic label 415 matches the preference parameters of the navigation device (step 610). In case of a match, the navigation device selectively applies the segment 410 to update a region of its map data (step 615). In case of no match, the step 615 is not executed, and the segment 410 is simply discarded by the navigation device. This method may be suitable when the server 302 broadcasts the segment information 410 in a common channel to be received by plural navigation devices. It can enable the amount of processing overhead, and memory access time, in each navigation device to be tailored by limiting the updating operation only to the geographic portions of the map set according to the update preference information of the navigation device.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

It should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

What is claim is:

1. A method of updating a digital map, comprising:
retrieving preference information defining a first portion of the digital map for which update information is desired;
acquiring update information selectively for the first portion of the digital map; and
applying the acquired update information to the digital map.

2. The method of claim 1, wherein the step of acquiring comprises acquiring the update information for the first portion of the digital map before acquiring update information for another portion of the digital map.

3. The method of claim 1, wherein the step of applying comprises applying the update information for the first portion of the digital map before applying update information for another portion of the digital map.

4. The method of claim 1, wherein the step of acquiring comprises prioritising acquisition of update information for the first portion of the digital map, compared to acquisition of update information for another portion of the digital map.

5. The method of claim 1, wherein the step of acquiring comprises selecting only update information for the first portion of the digital map.

6. The method of claim 1, wherein the first portion is defined by a geographic region surrounding at least one predetermined location.

7. The method of claim 6, wherein the at least one predetermined location includes a pre-registered location.

8. The method of claim 6, wherein the at least one predetermined location includes a current location.

9. The method of claim 6, wherein the at least one predetermined location includes at least one traveled or planned navigation route.

10. The method of claim 1, further comprising the steps of:
generating on a display device a display of user selectable options for defining the preference information; and
receiving user inputs to select the user selectable options.

11. The method of claim 10, further comprising the step of determining said first portion of the digital map from the user selectable options.

12. A method of providing map update information for an apparatus for storing a digital map, the method comprising:
providing the update information in segments of information, each segment relating to a respective geographical area of the digital map to be updated smaller than the overall size of the digital map; and
providing a label for each segment of update information, the label identifying the respective geographical area of the digital map for which the segment contains update information.

13. The method of claim 12, further comprising the step of selectively transmitting to the apparatus, segments that correspond to request criteria provided by the apparatus.

14. The method of claim 12, wherein each segment comprises update information that meets at least one of:
(a) the segment has a data size not exceeding a predetermined number of KiloBytes;
(b) the geographical area covered by the updating information does not exceed beyond a predetermined geographical boundary.

15. Apparatus for presenting a display of a digital map, comprising
a processor;
memory for storing a digital map and preference information;
a communication port for receiving segments of map update information a map updater module configured to cause the processor to:
(a) retrieving preference information defining a first portion of the digital map for which update information is desired;
(b) acquire update information selectively for the first portion of the digital map, via the communication port; and
(c) apply the acquired update information to the digital map.

16. The apparatus of claim 15, wherein the apparatus further comprises at least one of:
a positioning system module for configuring the processor to determine a real time location of the apparatus, based on received positioning system signals; and
a navigation module for configuring the processor to implement a navigation function using the digital map.

17. The apparatus of claim 15, further comprising a user preference display module for configuring the processor to:
generate on a display device a display of user selectable options for defining the preference information; and
receive user inputs to select the user selectable options

18. The apparatus of claim 15, wherein the map updater module is configured to control the processor to prioritise acquisition of update information for the first portion of the digital map, compared to acquisition of update information for another portion of the digital map.

19. The apparatus of claim 15, wherein the map updater module is configured to control the processor to select only update information for the first portion of the digital map.

20. The apparatus of claim 15, wherein the first portion is defined by a geographic region surrounding at least one predetermined location.

21. The apparatus of claim 20, wherein the at least one predetermined location includes a pre-registered location that is stored in the memory.

22. The apparatus of claim 20, wherein the at least one predetermined location includes a current location.

23. The apparatus of claim 20, wherein the at least one predetermined location includes at least one traveled or planned navigation route.

24. The apparatus of claim 15, wherein the apparatus is a portable navigation device.

25. A computer program configured to control a processor to execute a method of updating a digital map, comprising:
retrieving preference information defining a first portion of the digital map for which update information is desired;
acquiring update information selectively for the first portion of the digital map; and
applying the acquired update information to the digital map.
